(19) United States
(12) Patent Application Publication
(10) Pub. No.: US 2006/0069720 A1
(43) Pub. Date: Mar. 30, 2006

(54) Video distributing system, video distributing method, and server

(75) Inventor: Manabu Shibutani, Kawasaki-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/229,807

(22) Filed: Sep. 20, 2005

(30) Foreign Application Priority Data
Sep. 27, 2004 (JP) 2004-280483

(51) Int. Cl. G06F 15/16

(52) U.S. Cl. 709/203

(57) ABSTRACT

A video distributing system comprises a server which distributes a video, and a client which requests video distribution to the server. The server comprises an application program which communicates with the client, and the client comprises a web browser comprising an application program which communicates with the server and a reproduction page in which a software which reproduces a video to be distributed from the server is incorporated. When accessing the server, the application program of the server is started up to make communication with the server, thereby controlling display of the reproduction page according to a request from the server.

### CROSS-REFERENCE TO RELATED APPLICATIONS

This application is based upon and claims the benefit of priority from prior Japanese Patent Application No. 2004-280483, filed Sep. 27, 2004, the entire contents of which are incorporated herein by reference.

### BACKGROUND OF THE INVENTION

1. Field of the Invention

The present invention relates to a video distributing system, video distributing method, and server.

2. Description of the Related Art

In recent years, there has been developed a recording/reproducing apparatus capable of providing users with an environment in which remote control is enabled from any place through a simple operation like a remote control unit. (for example, Japanese Patent Application KOKAI Publication No. 2004-186770 (paragraphs [0009], [0010])).

Here, there is disclosed that a personal computer is connected to a recording/reproducing apparatus via a network such as Internet to make communication between the recording/reproducing apparatus and the personal computer, thereby performing remote control. A user of the personal computer accesses the recording/reproducing apparatus via a web browser to transmit a remote control function startup request to an HTTP (Hypertext Transfer Protocol) server in the recording/reproducing apparatus. The HTTP server transmits to the personal computer a predetermined program (remote control applet) for displaying a remote control screen having interface similar to that in the remote control unit on the personal computer. When a button on the remote control screen of the personal computer is operated by the user, a remote control code corresponding to the operated button is transmitted to the HTTP server via the web browser. In this manner, the transmission processing operation of the remote control code through the personal computer is performed under the control of the remote control applet transmitted from the recording/reproducing apparatus to the personal computer. Therefore, only the web browser has to be prepared on the personal computer side, and it is not necessary at all to prepare a dedicated program and the like to perform remote control on the recording/reproducing apparatus. Thus, an ordinary information processing terminal executable by web browser, such as not only a personal computer but also a portable phone, can perform remote control on the recording/reproducing apparatus.

As described above, since the personal computer can request the recording/reproducing apparatus to reproduce a video or stop a palyback, there is considered to construct a system where, using the recording/reproducing apparatus as a server and the personal computer as a client, a video is distributed from the recording/reproducing apparatus to the personal computer in response to a request from the personal computer so that a video similar to the video output on a TV monitor by the recording/reproducing apparatus can be viewed or listened to on the personal computer.

However, if authentication in the personal computer is successful, the recording/reproducing apparatus distributes a video according to a video reproduction request and cannot control distribution depending on the video type. Thus, even when a copyright of a video to be reproduced has been protected, the video to be reproduced is distributed to the personal computer in response to the request, and consequently there is a problem that the copyright is violated in the personal computer and the video is freely utilized.

As described above, there is a drawback that distribution cannot be controlled on the server side in the conventional system where a server and a client are connected through a network and a video is distributed from the server to the client in response to a request from the client.

### BRIEF SUMMARY OF THE INVENTION

It is an object of the present invention to provide a video distributing system, a video distributing method, and a server capable of controlling distribution of a video on the server.

According to an embodiment of the present invention, a video distributing system comprises a server which distributes a video; and a client which requests video distribution to the server, wherein the server comprises an application program which communicates with the client, and the client comprises a web browser comprising an application program which communicates with the server and a reproduction page in which a software which reproduces a video to be distributed from the server is incorporated, and when accessing the server, the application program of the server is started up to make communication with the server, thereby controlling display of the reproduction page according to a request from the server.

According to another embodiment of the present invention, a video distributing method for distributing a video from a server to a client, the server comprising an application program which communicates with the client, and the client comprising a web browser comprising an application program which communicates with the server and a reproduction page in which a software which reproduces a video to be distributed from the server is incorporated, the method comprising the steps of when the client accesses the server, starting up the application program of the client to communicate with the server, and controlling display of the reproduction page according to a request from the server.

According to another embodiment of the present invention, a server in a video distributing system comprising means for displaying a viewing window on a web browser of a client according to a startup request from the client; means for displaying a reproduction page in which a video reproduction software is incorporated on the web browser of the client in a reproducible state when a reproduction request from the client is issued; and means for displaying a stop page on the web browser of the client at least one of a case in a non-reproducible state where the reproduction request from the client is issued and a case where the non-reproducible state is established during reproduction.

### BRIEF DESCRIPTION OF THE SEVERAL VIEWS OF THE DRAWING

The accompanying drawings, which are incorporated in and constitute a part of the specification, illustrate embodiments of the present invention and, together with the general description given above and the detailed description of the embodiments given below, serve to explain the principles of the present invention in which:

FIG. 1 is a block diagram showing an embodiment of a video distributing system according to the present invention;

FIG. 2 is a block diagram showing a client machine in the video distributing system;

FIG. 3 is a diagram showing an operation when accessing a video distribution web page (server machine) through a web browser on the client machine;

FIG. 4 is a diagram showing an operation when pressing an open button of Java® applet on the client machine;

FIG. 5 is a diagram showing an operation when a reproduction notification is issued from the server machine;

FIG. 6 is a diagram showing an operation when a stop notification is issued from the server machine;

FIG. 7 is a diagram showing an operation when pressing a close button of Java® applet on the client machine;

FIG. 8 shows an example of HTML on a stop page; and

FIG. 9 shows an example of HTML on a reproduction page.

### DETAILED DESCRIPTION OF THE INVENTION

An embodiment of a video distributing system apparatus according to the present invention will now be described with reference to the accompanying drawings.

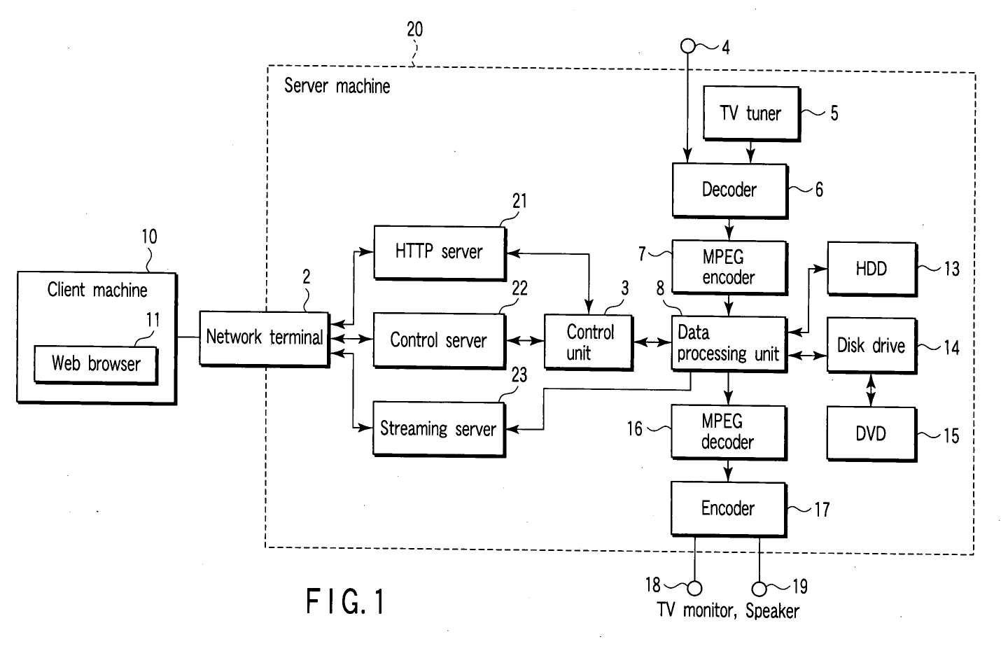

FIG. 1 is a diagram showing a structure of the video distributing system according to the embodiment of the present invention. The present system comprises a server machine 20 including a digital versatile disc (DVD) having a recording/reproducing function and a client machine 10 including a personal computer, and the client machine 10 and the server machine 20 are connected via a network. The client machine 10 includes a web browser 11, and a user can access the server machine 20 through the web browser 11 to request video distribution to the server machine 20.

The server machine 20 has a TV (television) tuner 5 or an external input terminal 4 capable of receiving terrestrial and satellite broadcast, and a video signal including an audio supplied therefrom is converted into a digital signal by a decoder 6. The converted video signal is supplied to an MPEG (Moving Picture Experts Group) encoder 7, where it is converted (compression-coded) into data in a form compatible with the MEPG format. The data after converted is recorded in a DVD disk (recording medium such as DVD-RAM or DVD-R) mounted in a hard disk drive (HDD) 13 or a DVD drive 14 through a data processing unit 8.

When the recorded video signal is reproduced, the MPEG data is read out from the HDD 13 or the DVD disk 15, which is supplied to an MPEG decoder 16 via the data processing unit 8. The DVD drive 14 can execute read processing from a reproduction-only medium such as DVD-ROM. A digital signal output from the MPEG decoder 16 is converted into an analog video signal and an analog audio signal through an encoder 17, which are output to a video output terminal 18 and an audio output terminal 19, respectively. The video signal output from the output terminal 18 is reproduced on the TV monitor (not shown), and the audio signal output from the output terminal 19 is reproduced on a speaker (not shown), respectively.

A series of entire control on each unit according to the above recording/reproducing is performed by a controller 3 as a microcomputer. The controller 3 is connected with an HTTP server 21 which receives a request of the video distributing server machine 20 from the client machine 10, a control server 22 which instructs the client machine 10 to reproduce a video or stop a playback or receives a request of notifying a status of the client machine 10, and a streaming server 23 which distributes a video to the client in response to a video distribution request form the client machine 10. These servers 21, 22 and 23 each have a network terminal 2 having a network connection function of connecting to a local area network (LAN) or the like.

The streaming server 23 is network-connected to the client machine 10 via the network terminal 2, acquires output data of the MPEG encoder 7 via the data processing unit 8 in response to a streaming request from the personal computer, and converts it into streaming protocol to transfer it to the client machine 10. The streaming server 23 can be achieved as software and would have the same function even if its control is achieved by the controller 3.

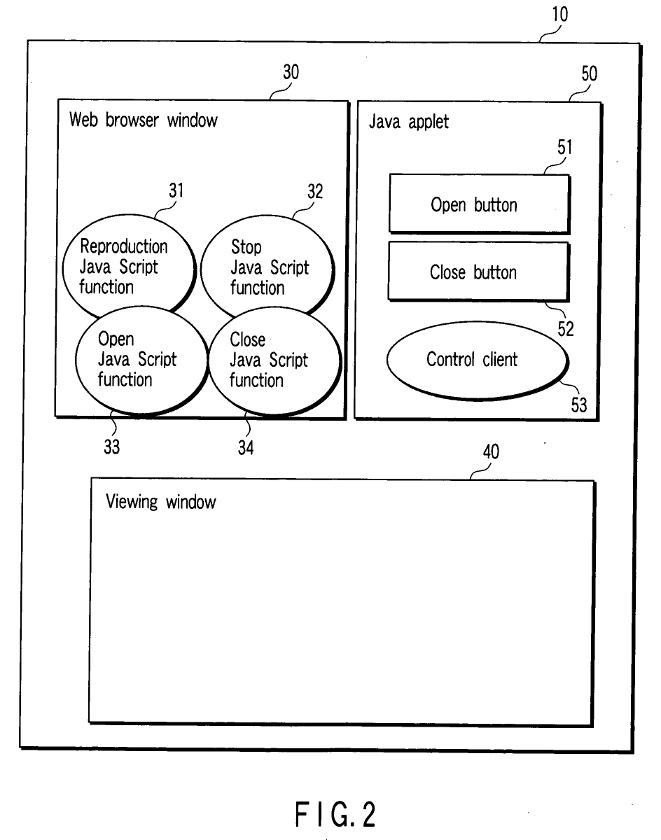

FIG. 2 is a block diagram showing a structure of the client machine 10 when a user accesses a video distribution web page (server machine 20) on the client machine 10 through the web browser 11 of FIG. 1. A web browser window 30 is a window of the web browser 11 from which the user has accessed the server machine 20, which includes a reproduction Java® script function 31 for reproducing a video, a stop Java® script function 32 for stopping a playback of video, an open Java® script function 33 for opening a viewing window 40, and a close Java® script function 34 for closing the viewing window 40.

The viewing window 40 is a browser window created by the open Java® script function 33, where a distributed video is actually displayed. Typically, when the browser window is opened, there is prohibited a user's operation such as hide setting of a menu bar including a “return” button to the previously-displayed page or an operation when the window is clicked through a mouse.

Java® applet 50 is started up by the server machine 20, which causes an open button 51 as a trigger for user's opening the viewing window 40 and a close button 52 as a trigger for closing the viewing window 40 to be displayed on the web browser and comprises a control client 53 for communicating with a control server in the server machine 20.

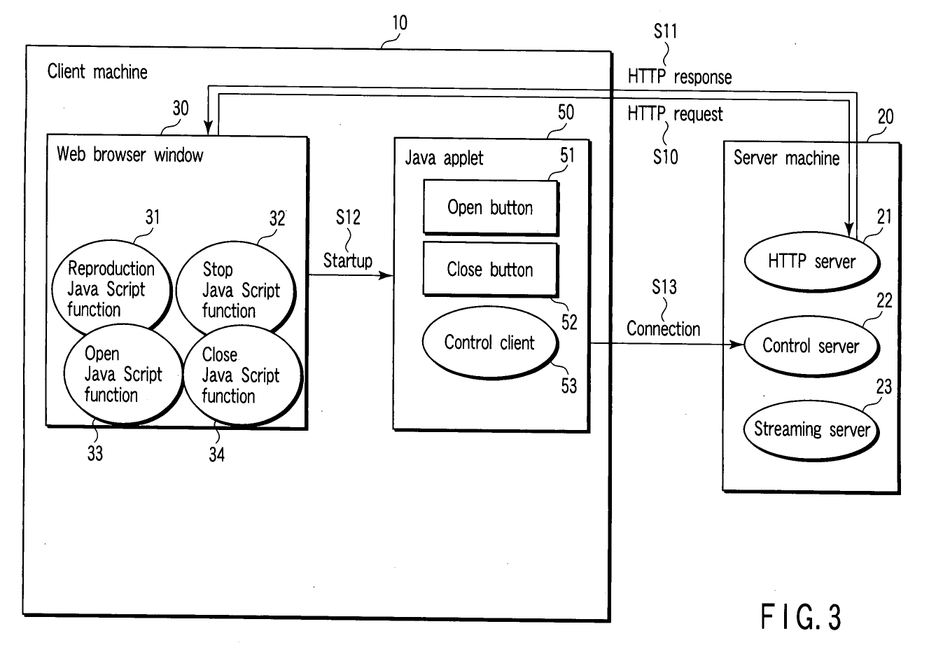

FIG. 3 is a diagram showing an operation when the user accesses the server machine 20 through the web browser 11 on the client machine 10. When the user accesses the server machine 20 on the web browser 11, a web page display request is transmitted to the HTTP server 21 in the server machine 20 (S10). The HTTP server 21 transmits display contents of the web page in response to the request (S11). The web page includes the reproduction Java® script function 31, the stop Java® script function 32, the open Java® script function 33 and the close Java® script function 34. The web page includes a script for starting up the Java® applet 50. Thus, when the web page is displayed, the Java® applet 50 is started up (S12). When the Java® applet 50 is started up, the control client 53 makes communication with the control server 22 of the server machine 20 (S13).

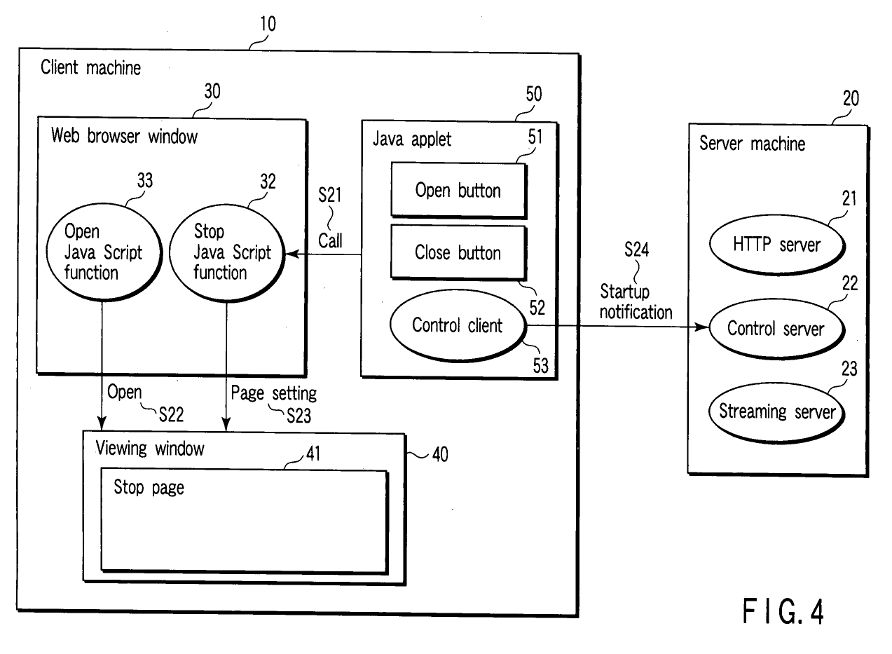

FIG. 4 is a diagram showing an operation when the user presses the open button 51 of the Java® applet 50 for opening the viewing window 40. When the open button 51 is pressed, the Java® applet 50 calls up the open Java® script function 3.3 included in the web page of the client machine 10 (S21). The open Java® script function 33 opens the viewing window 40 on the screen of the client machine 10 (S22).

When the viewing window 40 is opened, video distribution has not been started. Thus, the Java® applet 50 continuously calls up the stop Java® script function 32 (S23). The stop Java® script function 32 displays a stop page 41 in the viewing window 40 (S23).

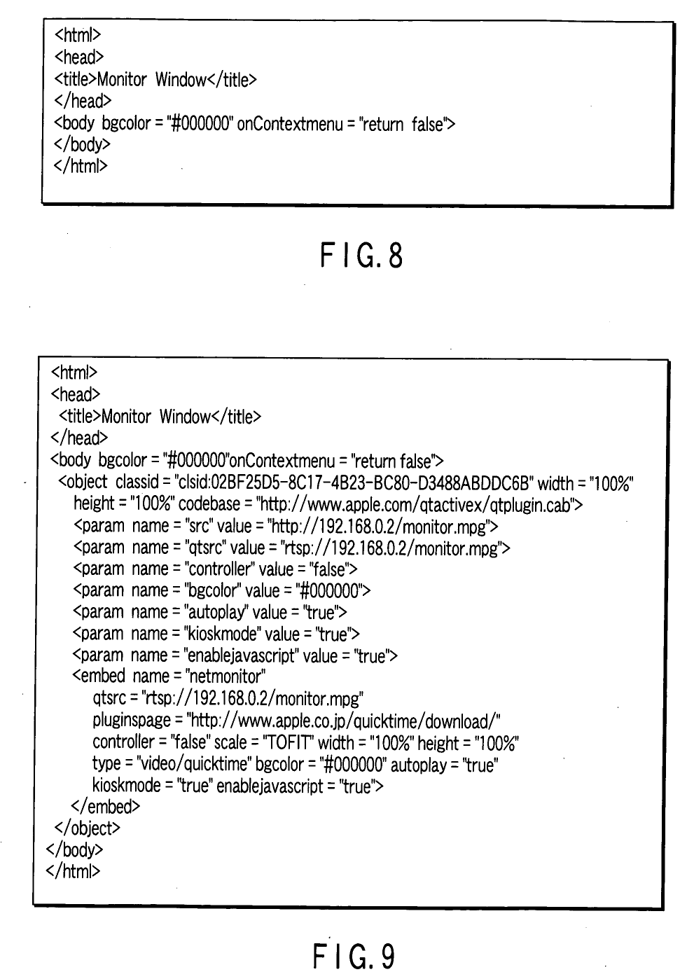

FIG. 8 shows an example of an HTML (Hypertext Markup Language) program for displaying the stop page 41. Since the stop page 41 is displayed when video distribution is being stopped, black background enables the user to easily understand that the video distribution is being stopped.

Thereafter, the control client 53 of the Java® applet 50 issues an open notification for notifying that the viewing window 40 has been opened to the control server 22 in the server machine 20 (S24).

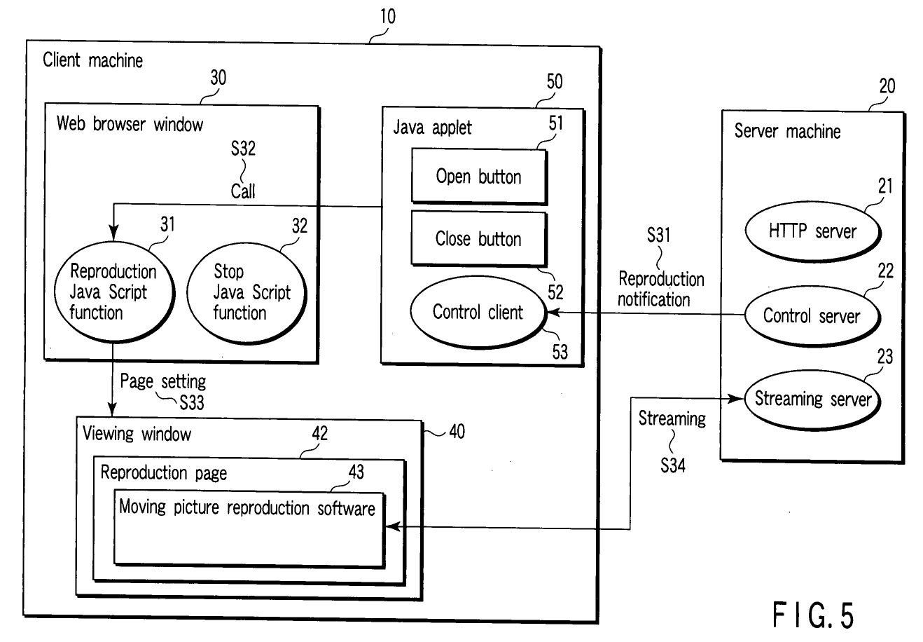

FIG. 5 is a block diagram when the server machine 20 issues a reproduction notification. When the server machine 20 receives a startup notification (FIG. 4, S24) from the control client 53 in the client machine 10, the reproduction notification is issued in the reproducible state (when a copyright of the video to be reproduced is protected) (S31), and the notification is not performed in the non-reproducible state (when a copyright of the video to be reproduced is not protected). Thus, the server machine 20 can control reproduction of video and stop playback of video in the client machine 10. When the Java® applet 50 receives the reproduction notification, it calls up the reproduction Java® script function 31 included in the web page of the client machine 10 (S32). The reproduction Java® script function 31 displays a reproduction page 42 on the viewing window 40 (S33). The reproduction page 42 is an area on which the video distributed in the viewing window 40 is displayed.

FIG. 9 shows an example of an HTML program for displaying the reproduction page 42. As shown in FIG. 9, a moving picture reproduction software 43 is embedded in (plugged in) the reproduction page 42, which is set such that when the reproduction page 42 is displayed, it is automatically connected to the streaming server 23 in the server machine 20 to reproduce the video. Therefore, when the reproduction page 42 is displayed, the moving picture reproduction software 43 embedded in the reproduction page 42 performs streaming with the streaming server 23 in the server machine 20 so that the video is displayed on the viewing window 40 (S34). During this time, the user is prohibited from operating reproduction and stop, and there is set such that the control bar such as reproduction and stop is not displayed on the viewing window 40.

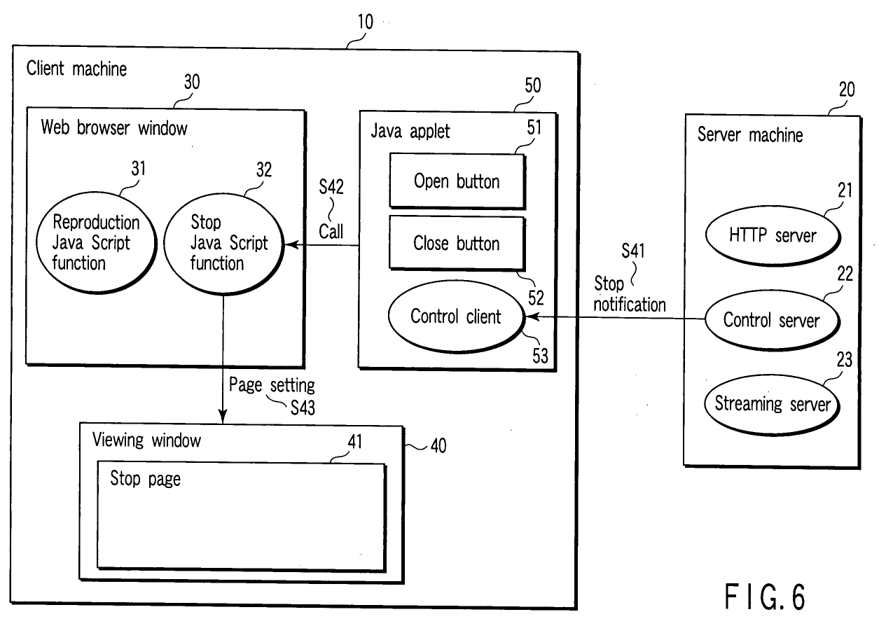

FIG. 6 is a diagram showing an operation when the server machine 20 enters the non-reproducible state during reproduction. When the server machine 20 enters the non-reproducible state during reproduction, it issues a stop notification to the client machine 10 (S41). When the Java® applet 50 receives the stop notification, it calls up the stop Java® script function 32 included in the web page of the client machine 10 (S42). The stop Java® script function 32 sets the stop page 41 in the viewing window 40 (S43). Thus, the reproduction page 42 in the viewing window 40 is prevented from being displayed, and the stop page 41 is displayed instead. Consequently, the streaming by the moving picture reproduction software 43 is stopped.

In this manner, the server machine 20 can interrupt reproduction even if it enters the non-reproducible state after the reproduction has been started based on the request from the client machine 10.

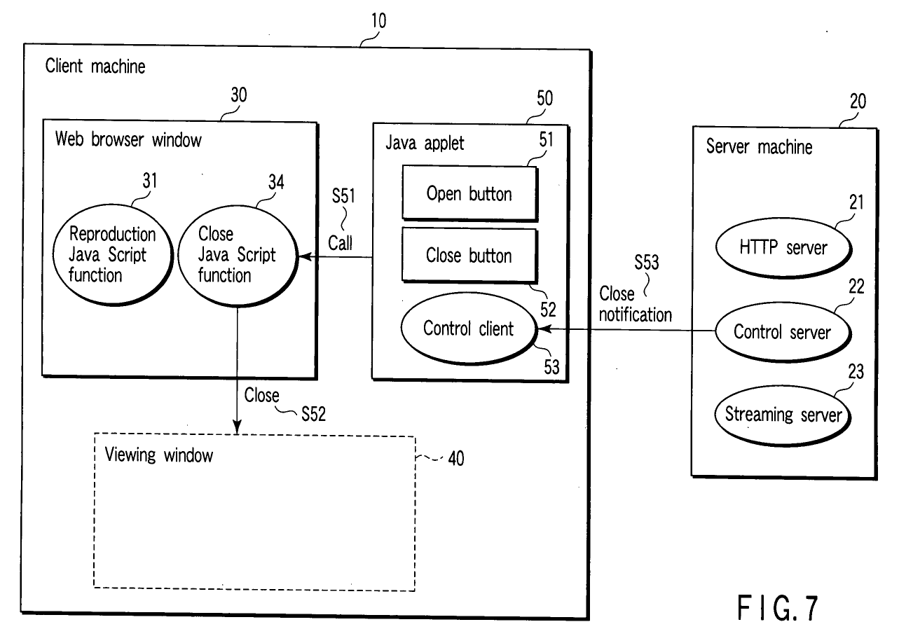

FIG. 7 is a diagram showing an operation when the user presses the close button 52 of the Java® applet 50 for closing the viewing window 40 during reproduction. When the close button 52 is pressed, the Java® applet 50 calls up the close Java® script function 34 included in the web page of the client machine 10 (S51). The close Java® script function 34 closes the viewing window 40 (S52). When the viewing window 40 is closed, displaying the reproduction page 42 is also stopped so that the streaming is stopped. The Java® applet 50 issues a close notification, to the server machine 20, for notifying that the viewing window 40 has been closed (S53). The server machine 20 knows that the viewing window 40 of the client machine 10 is being closed by receiving the close notification.

According to the embodiment described above, the system comprises a web browser including an application for communicating between a client and a server and a software-incorporated reproduction page for reproducing a video to be distributed from the server. When the client accesses the server, the communication application is started up to make communication with the server, and the software controls displaying of the web browser according to a request from the server, so that the display on the web browser is dynamically controlled according to the request from the server, thereby operating reproduction of a video and stop playback of a video. Thus, when the moving picture reproduction software embedded in the reproduction page in the viewing window of the web browser is used to distribute a video, an application communicable with the server side is included in the web browser window and this application switches the display page of the browser according to the request from the server side, thereby operating reproduction and stop of the video as the server intends.

While the description above refers to particular embodiments of the present invention, it will be understood that many modifications may be made without departing from the spirit thereof. The accompanying claims are intended to cover such modifications as would fall within the true scope and spirit of the present invention. The presently disclosed embodiments are therefore to be considered in all respects as illustrative and not restrictive, the scope of the invention being indicated by the appended claims, rather than the foregoing description, and all changes that come within the meaning and range of equivalency of the claims are therefore intended to be embraced therein. For example, some structural components may be deleted from the entire structural components shown in the embodiment. Furthermore, structural components leading to different embodiments may be combined appropriately. The present invention can be practiced as a computer readable recording medium in which a program for allowing the computer to function as predetermined means, allowing the computer to realize a predetermined function, or allowing the computer to conduct predetermined means.

What is claimed is:

1. A video distributing system comprising:
a server which distributes a video; and
a client which requests video distribution to the server, wherein
the server comprises an application program which communicates with the client, and
the client comprises a web browser comprising an application program which communicates with the server and a reproduction page in which a software which reproduces a video to be distributed from the server is incorporated, and when accessing the server, the application program of the server is started up to make communication with the server, thereby controlling display of the reproduction page according to a request from the server.

2. The video distributing system according to claim 1, wherein the web browser includes a reproduction function and a stop function, calls up the reproduction function to display the reproduction page when the application program of the client receives a reproduction request from the server, and calls up the stop function to stop displaying the reproduction page when the communication application receives a stop request from the server.

3. The video distributing system according to claim 1, wherein the web browser displays an open button and a close button, includes an open function and a close function, and when the open button is operated, calls up the open function to display a viewing window, and when the close button is operated, calls up the close function to close the viewing window so that the reproduction page is displayed on the viewing window.

4. The video distributing system according to claim 1, wherein the software is an application program incorporated on a page of the web browser in a mark-up language.

5. A video distributing method for distributing a video from a server to a client, the server comprising an application program which communicates with the client, and the client comprising a web browser comprising an application program which communicates with the server and a reproduction page in which a software which reproduces a video to be distributed from the server is incorporated, the method comprising the steps of:
when the client accesses the server, starting up the application program of the client to communicate with the server, and
controlling display of the reproduction page according to a request from the server.

6. The video distributing method according to claim 5, wherein the web browser includes a reproduction function and a stop function, calls up the reproduction function to display the reproduction page when the application program of the client receives a reproduction request from the server, and calls up the stop function to stop displaying the reproduction page when the communication application receives a stop request from the server.

7. The video distributing method according to claim 5, wherein the web browser displays an open button and a close button, includes an open function and a close function, and when the open button is operated, calls up the open function to display a viewing window, and when the close button is operated, calls up the close function to close the viewing window so that the reproduction page is displayed on the viewing window.

8. The video distributing method according to claim 5, wherein the software is an application program incorporated on a page of the web browser in a mark-up language.

9. A server in a video distributing system comprising:
means for displaying a viewing window on a web browser of a client according to a startup request from the client;
means for displaying a reproduction page in which a video reproduction software is incorporated on the web browser of the client in a reproducible state when a reproduction request from the client is issued; and
means for displaying a stop page on the web browser of the client at least one of a case in a non-reproducible state where the reproduction request from the client is issued and a case where the non-reproducible state is established during reproduction.

10. The server according to claim 9, wherein the web browser includes a reproduction function and a stop function, calls up the reproduction function to display the reproduction page when the application program of the client receives a reproduction request from the server, and calls up the stop function to stop displaying the reproduction page when the communication application receives a stop request from the server.

11. The server according to claim 9, wherein the web browser displays an open button and a close button, includes an open function and a close function, and when the open button is operated, calls up the open function to display a viewing window, and when the close button is operated, calls up the close function to close the viewing window so that the reproduction page is displayed on the viewing window.

12. The server according to claim 9, wherein the software is an application program incorporated on a page of the web browser in a mark-up language.
